(19) United States
(12) Patent Application Publication
(10) Pub. No.: US 2023/0245271 A1
(43) Pub. Date: Aug. 3, 2023

(54) Videoconferencing Systems with Facial Image Rectification

(71) Applicant: Polycomm Communications Technology ( Beijing) Co. Ltd., Beijing (CN)

(72) Inventors: Hailin Song, Beijing (CN); Hai Xu, Beijing (CN); Yongkang Fan, Beijing (CN); Tianran Wang, Beijing (CN); Xi Lu, Beijing (CN)

(21) Appl. No.: 18/004,578

(22) PCT Filed: Jul. 6, 2020
(86) PCT No.: PCT/CN2020/100372

§ 371 Date: Jan. 6, 2023

(51) Int. Cl. G06T 3/40; G06T 7/10; G06V 40/16; G06V 10/82; G06V 20/40; H04N 7/15

(52) U.S. Cl. CPC G06T 3/4038; G06T 7/10; G06V 40/171; G06V 10/82; G06V 20/46; H04N 7/15; G06T 2207/10016; G06T 2207/20081; G06T 2207/20084; G06T 2207/30201

(57) ABSTRACT

A real-time method (600) for enhancing facial images (102). Degraded images (102) of a person—such as might be transmitted during a videoconference—are rectified based on a single high definition reference image (604) of a person who is talking. Facial landmarks (501) are used to map (210) image data from the reference image (604) to an intervening image (622) having a landmark configuration like that in a degraded image (102). The degraded images (102) and their corresponding intervening images (622) are blended using an artificial neural network (800, 900) to produce high-quality images (108) of the person who is speaking during a videoconference.

### TECHNICAL FIELD

This disclosure relates generally to videoconferencing and relates particularly to rectifying images livestreamed during a videoconference.

### BACKGROUND

During a real-time videoconference, people at a videoconferencing endpoint interact with people at one or more other videoconferencing endpoints over a network. When the data transmission error rate of the network is too high, or the data transmission rate of the network is too low, the quality of transmitted images can suffer. Attempts to compensate for such network shortcomings, especially as they pertain to transmission of images containing faces, have not been wholly successful. Thus, there is room for improvement in the art.

### SUMMARY

An example of this disclosure is a method of rectifying images in a videoconference. The method includes: receiving a first image frame; determining locations of first feature landmarks corresponding to the first image frame; determining a first region corresponding to the first image frame, based on the locations of the first feature landmarks; partitioning the first region into a first plurality of polygons based on the locations of the first feature landmarks; receiving a second image frame; determining locations of second feature landmarks corresponding to the second image frame; determining a second region corresponding to the second image frame, based on the locations of the second feature landmarks; partitioning the second region into a second plurality of polygons based on the locations of the second feature landmarks; translating image data of one or more polygons of the first plurality of polygons to one or more polygons of the second plurality of polygons; and forming a composite image frame by replacing image data of at least one polygon in the second plurality of polygons with translated image data from the one or more polygons of the first plurality of polygons. In another example of this disclosure, the method also includes: receiving the first image frame at a neural processing unit; receiving the composite image frame at the neural processing unit; and forming a rectified image frame using the neural processing unit, based on the first image frame and the composite image frame.

Another example of this disclosure is a videoconferencing system with a processor that is operable to: receive a first image frame; determine locations of first feature landmarks corresponding to the first image frame; determine a first region corresponding to the first image frame, based on the locations of the first feature landmarks; partition the first region into a first plurality of polygons based on the locations of the first feature landmarks; receive a second image frame; determine locations of second feature landmarks corresponding to the second image frame; determine a second region corresponding to the second image frame, based on the locations of the second feature landmarks; partition the second region into a second plurality of polygons based on the locations of the second feature landmarks; translate image data of one or more polygons of the first plurality of polygons to one or more polygons of the second plurality of polygons; and form a composite image frame by replacing image data of at least one polygon in the second plurality of polygons with translated image data from the one or more polygons of the first plurality of polygons. In one or more examples of this disclosure, the videoconferencing system is operable to: receive the first image frame at a neural processing unit; receive the composite image frame at the neural processing unit; and form a rectified image frame using the neural processing unit, based on the first image frame and the composite image frame.

### BRIEF DESCRIPTION OF THE DRAWINGS

For illustration, there are shown in the drawings certain examples described in the present disclosure. In the drawings, like numerals indicate like elements throughout. The full scope of the inventions disclosed herein are not limited to the precise arrangements, dimensions, and instruments shown. In the drawings.

FIG. 1A illustrates an image frame which has been enhanced using a conventional technique;

FIG. 1B illustrates an image frame which has been rectified, in accordance with an example of this disclosure;

FIG. 2 illustrates a method of rectifying facial image frames, in accordance with an example of this disclosure;

FIG. 3 illustrates a videoconferencing system, in accordance with an example of this disclosure;

FIG. 4 illustrates aspects of the videoconferencing system, in accordance with an example of this disclosure;

FIG. 5 illustrates aspects of facial landmark analysis, in accordance with an example of this disclosure;

FIG. 6 illustrates aspects of a method of rectifying facial image frames, in accordance with an example of this disclosure;

FIG. 7 illustrates an artificial neural network architecture, in accordance with an example of this disclosure;

FIG. 8 is a U-Net data flow diagram, in accordance with an example of this disclosure;

FIG. 9 is a VDSR data flow diagram, in accordance with an example of this disclosure; and

FIG. 10 illustrates an electronic device which can be used to practice one or more methods of this disclosure.

### DETAILED DESCRIPTION

In the drawings and the description of the drawings herein, certain terminology is used for convenience only and is not to be taken as limiting the examples of the present disclosure. In the drawings and the description below, like numerals indicate like elements throughout.

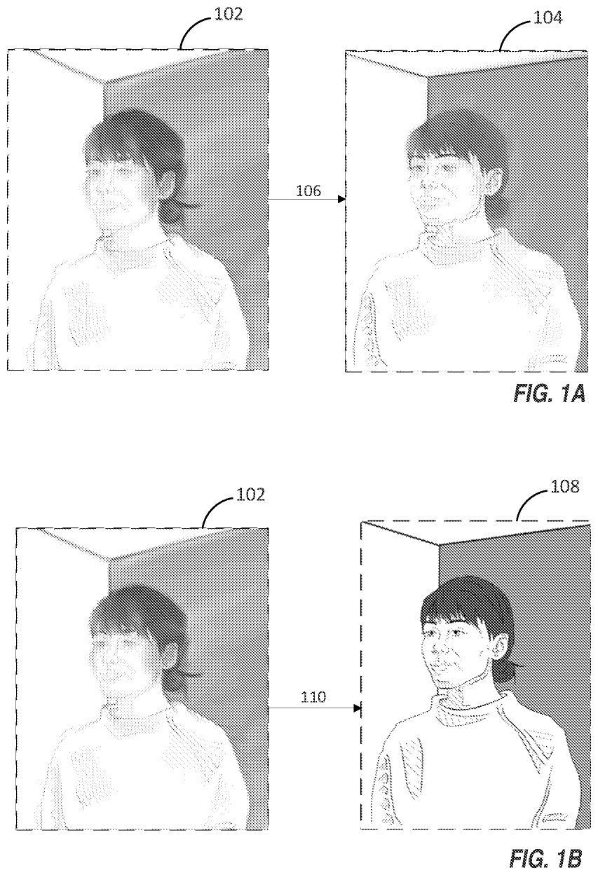

FIG. 1A and FIG. 1B show image frames of a videoconference participant, Ms. Polly. FIG. 1A illustrates a first image frame 102 of poor quality and a second image frame 104 which is a (somewhat) improved version of image frame 102. The second image frame 104 has been produced by enhancing 106 the first image frame 102 using one or more conventional image enhancement techniques.

FIG. 1B illustrates a third image frame 108 which is also based on the first image frame 102. The third image frame 108 has been produced 110 using one or more image rectification methods of this disclosure. The image quality of the third image frame 108 is markedly superior to the quality of the image frame 104 produced using conventional methods.

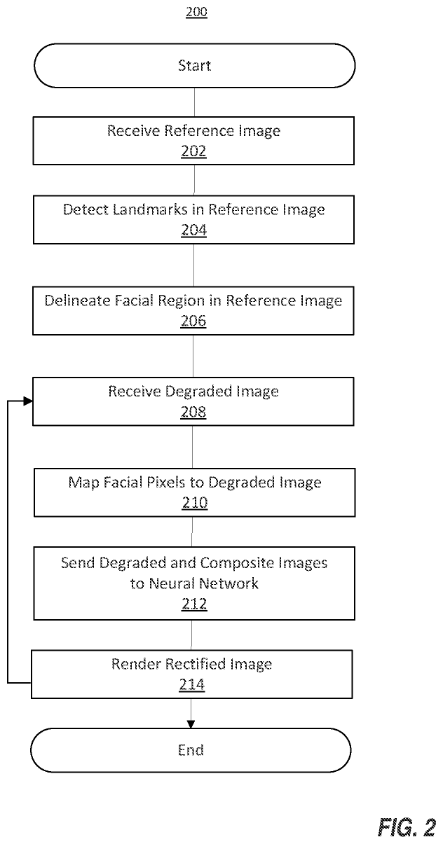

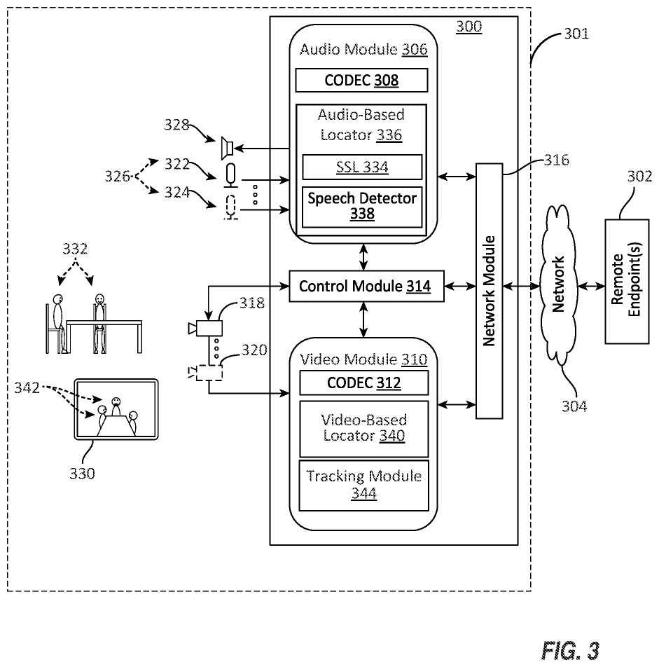

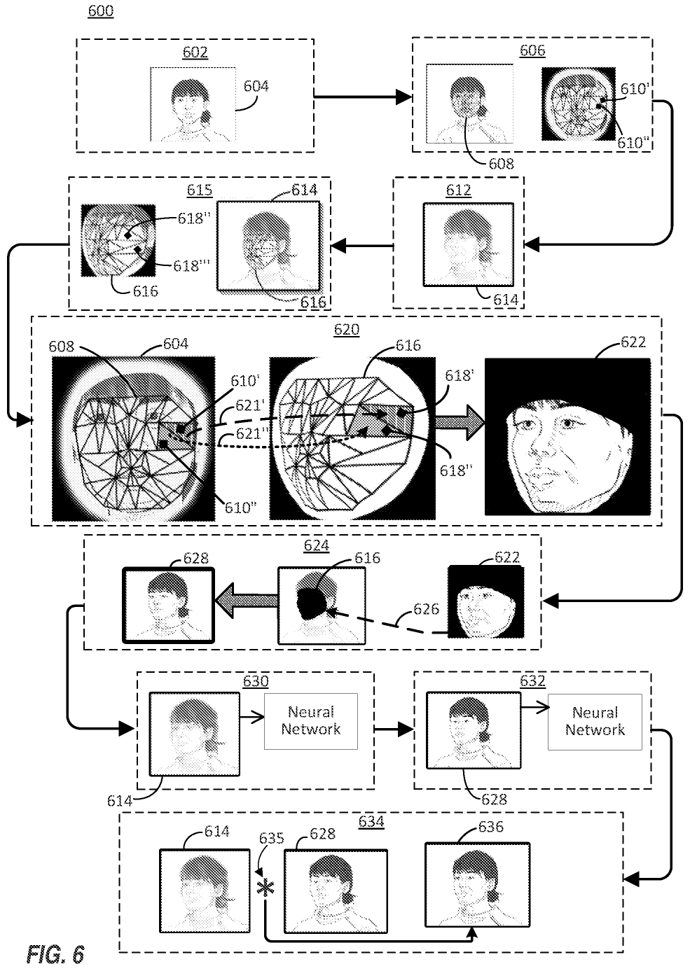

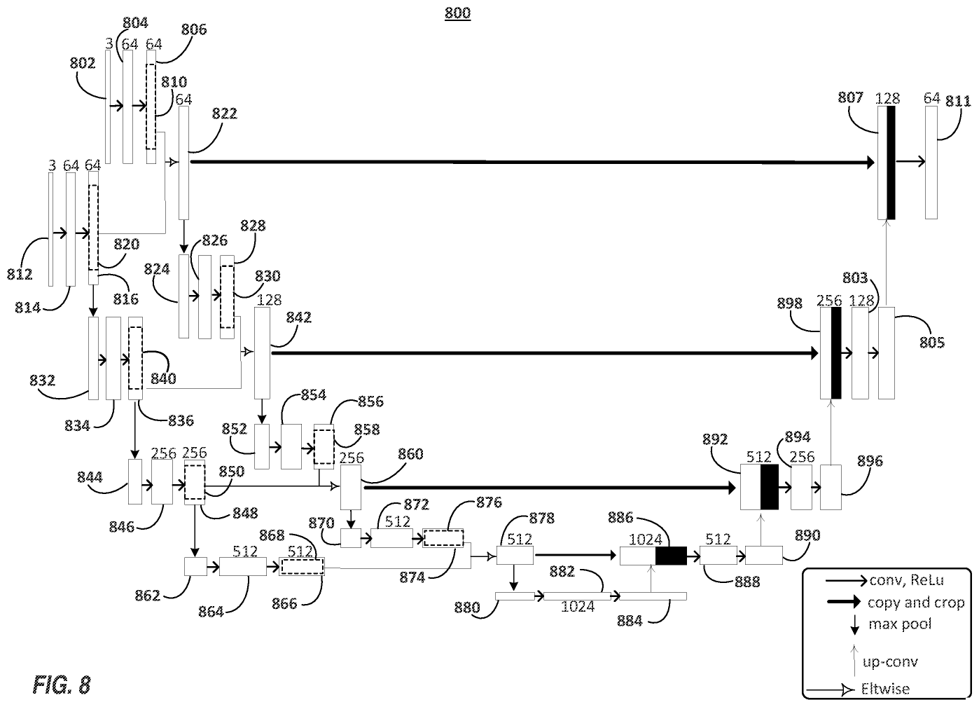

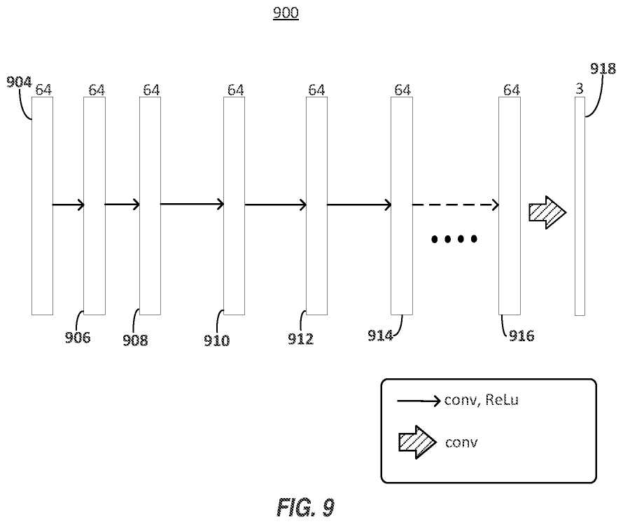

By way of introduction, FIG. 2 illustrates a real-time method 200 of rectifying poor-quality facial images (e.g., 102) so that better-quality versions can be displayed instead, e.g., during a videoconference. In accordance with the method 200, a high-quality image frame of a person (see e.g., 604, FIG. 6) is received 202 at a videoconferencing endpoint (see e.g., 301, FIG. 3), and facial landmarks within the high-quality image frame (see e.g., 501, FIG. 5) are detected 204. The high-quality image frame will be used as a reference frame. The locations of the facial landmarks are used to identify 206 a facial region within the reference frame. The facial region of the reference frame is subdivided into polygonal regions (see e.g., 606, FIG. 6). In some examples of this disclosure, some or all the polygons in the facial region have at least one landmark a vertex. During the videoconference, a stream of image frames containing the person (e.g., Ms. Polly) are received 208. If the quality of an image frame (e.g., 102) is poor, facial landmarks are used to subdivide the facial region of the streamed image frame (e.g., 102), as was done to the reference image frame (see e.g., 615, FIG. 6). Facial pixel data of a given polygon in the reference image frame can be mapped 210 to a corresponding polygon in the damaged frame (see e.g., 620, FIG. 6). A composite image frame is thereby formed, in which pixels in the (damaged) poor-quality image frame are replaced by mapped pixels (see 628, FIG. 6). Thereafter, the degraded image frame and the composite image frame can be passed 212 to one or more artificial neural networks (see FIGS. 8-9) which are used to produce a high-quality rectified image frame like image frame 108 of FIG. 1B. The rectified image frame can be rendered 214 (e.g., displayed on a display device), and the method 200 can end, or if additional low-quality image frames of Ms. Polly are received, they can also be rectified based on her reference image frame.

In some examples of this disclosure, a rectified image frame- or some portion thereof—formed during the teleconference can subsequently be used as a reference frame. In some examples of this disclosure, a recently received high-quality image frame can replace an earlier reference frame. For example, before a videoconference, Ms. Polly might provide a high-quality image of herself, such as from a photographic identification card. Transmission quality of the videoconference might initially be poor, so the image from the photo ID will be used as a reference frame. Later in the videoconference, transmission quality might improve, and one or more high-quality image frames of Ms. Polly could be received. It may be advantageous to use a more recently received high-quality image frame as a reference frame should the quality of the transmission again decline.

FIG. 3 illustrates a videoconferencing system 300 at a videoconferencing endpoint 301, in accordance with an example of this disclosure. The videoconferencing system 300 includes multiple components to provide a pleasant videoconferencing experience. The videoconferencing system 300 enables people at the videoconferencing endpoint 301 to communicate with people at one or more remote videoconferencing endpoints 302 over a network 304. Components of the (videoconferencing) system 300 include an audio module 306 with an audio codec 308, and a video module 310 with a video codec 312. Video module 310 includes a video-based locator 340, which is used to locate videoconference participants 332 (e.g., Ms. Polly) during videoconferences. Video module 310 also includes a tracking module 344, which is used to track the locations of videoconference participants 332 at the videoconferencing endpoint 301. Audio module 306 and video module 310 are operatively coupled to a control module 314 and a network module 316. The (videoconferencing) system 300 includes and/or is coupled to least one camera 318 at the (videoconferencing) endpoint 301. The camera(s) 318 can be used to capture a video component of a data stream at the endpoint 301. Such a data stream contains a series of frames, which can include image frames and related audio; a given image frame can consist of one or more contiguous and/or non-contiguous image frames as well as one or more overlapping or non-overlapping image frames. n some examples of this disclosure, the endpoint 301 includes one or more additional cameras 320. The camera(s) 318 can be used to detect (video) data indicating a presence of one or more persons (e.g., participants 332) at the endpoint 301. In some examples, when a participant 332 is zoomed in upon by a camera (e.g., 318), a sub-portion of the captured image frame containing the participant 332 is rendered—e.g., displayed on a display 330 and/or transmitted to a remote endpoint 302 —whereas other portions of the image frame are not.

During a videoconference, camera 318 captures video and provides the captured video to the video module 310. In at least one example of this disclosure, camera 318 is an electronic pan-tilt-zoom (EPTZ) camera. In some examples, camera 318 is a smart camera. Additionally, one or more microphones (e.g., 322, 324) capture audio and provide the captured audio to the audio module 306 for processing. The captured audio and concurrently captured video can form a data stream. (See preceding paragraph.) Microphone 322 can be used to detect (video) data indicating a presence of one or more persons (e.g., participants 332) at the endpoint 301. The system 300 can use the audio captured with microphone 322 as conference audio.

In some examples, the microphones 322, 324 can reside within a microphone array (e.g., 326) that includes both vertically and horizontally arranged microphones for determining locations of audio sources, e.g., participants 332 who are speaking.

After capturing audio and video, the system 300 encodes the captured audio and video in accordance with an encoding standard, such as MPEG-1, MPEG-2, MPEG-4, H.261, H.263, and H.264 and their descendants. Then, the network module 316 outputs the encoded audio and video to the remote endpoints 302 via the network 304 using an appropriate protocol. Similarly, the network module 316 receives conference audio and video through the network 304 from the remote endpoints 302 and transmits the received audio and video to their respective codecs 308/312 for processing. Endpoint 301 also includes a loudspeaker 328 which outputs conference audio, and a display 330 which outputs conference video.

Using camera 318, the system 300 can capture a view of a room at the endpoint 301, which would typically include all (videoconference) participants 332 at the endpoint 301, as well as some of their surroundings. According to some examples, the system 300 uses camera 318 to capture video of one or more participants 332, including one or more current talkers, in a tight or zoom view. In at least one example, camera 318 is associated with a sound source locator (e.g., 334) of an audio-based locator (e.g., 336).

In one or more examples, the system 300 may use the audio-based locator 336 and a video-based locator 340 to determine locations of participants 332 and frame views of the environment and participants 332. The control module 314 may use audio and/or video information from these locators 336, 340 to crop one or more captured views, such that one or more subsections of a captured view will be displayed on a display 330 and/or transmitted to a remote endpoint 302.

In some examples, to determine how to configure a view, the control module 314 uses audio information obtained from the audio-based locator 336 and/or video information obtained from the video-based locator 340. For example, the control module 314 may use audio information processed by the audio-based locator 336 from one or more microphones (e.g., 322, 324). In some examples, the audio-based locator 336 includes a speech detector 338 which can be used to detect speech in audio captured by microphones 322, 324 to determine a location of a current participant 332. In some examples, the control module 314 uses video information captured using camera 318 and processed by the video-based locator 340 to determine the locations of participants 332 and to determine the framing for captured views.

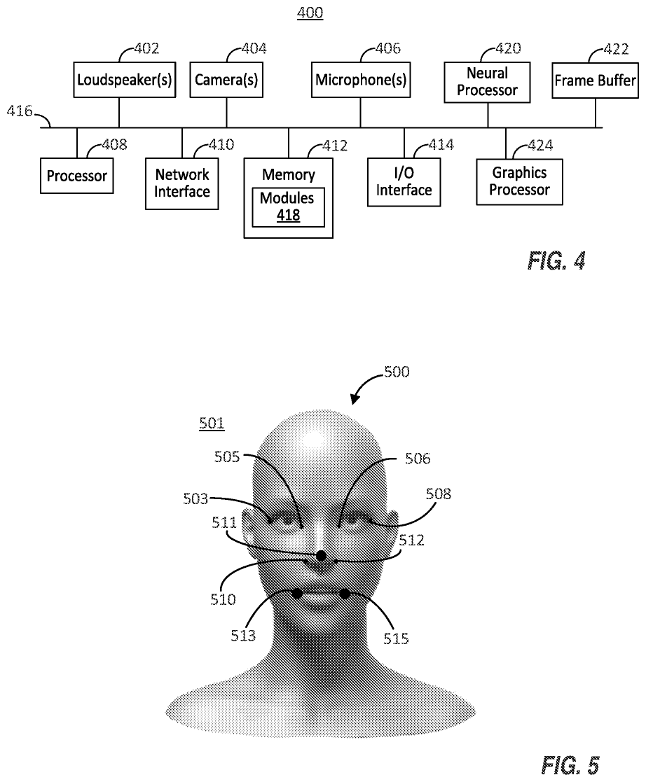

FIG. 4 illustrates components 400 of the videoconferencing system 300, in accordance with an example of this disclosure. The components 400 include one or more loudspeaker(s) 402 (e.g., 328), one or more camera(s) 404 (e.g., 318) and one or more microphone(s) 406 (e.g., 322, 324). The components 400 also include a processor 408, a network interface 410, a memory 412, a general input/output interface 414, a neural processor 420, a frame buffer 422, and a graphics processor 424, all coupled by bus 416.

The memory 412 can be any standard memory such as SDRAM. The memory 412 stores modules 418 in the form of software and/or firmware for controlling the system 300. In addition to audio codec 308 and video codec 312, and other modules discussed previously, the modules 418 can include operating systems, a graphical user interface that enables users to control the system 300, and algorithms for processing audio/video signals and controlling the camera(s) 404.

The network interface 410 enables communications between the endpoint 301 and remote endpoints 302. In one or more examples, the network interface 410 provides data communication with local devices such as a keyboard, mouse, printer, overhead projector, display, external loudspeakers, additional cameras, and microphone pods, etc.

The camera(s) 404 and the microphone(s) 406 capture video and audio in the videoconference environment, respectively, and produce video and audio signals transmitted through bus 416 to the processor 408. In at least one example of this disclosure, the processor 408 processes the video and audio using algorithms of modules 418. For example, the system 300 processes the audio captured by the microphone(s) 406 as well as the video captured by the camera(s) 404 to determine the location of participants 332 as well as to control and select from the views of the camera(s) 404. Processed audio and video can be sent to remote devices coupled to network interface 410 and devices coupled to general interface 414.

The frame buffer 422 buffers frames of both incoming (from the video camera 404) and outgoing (to the video display 330) video streams, enabling the system 300 to process the streams before routing them onward. If the video display (330) accepts the buffered video stream format, the processor 408 routes the outgoing video stream from the frame buffer 422 to the display 330 (e.g., via input-output interface 414).

Although the processor 408 may be able to process the buffered video frames, in some examples of this disclosure, faster and more power-efficient operations can be achieved using a neural processing unit (e.g., neural processor) 420 and/or a graphics processing unit 424 to perform such processing. In some examples of this disclosure, graphics processing unit 424 employs circuitry optimized for vector functions, whereas neural processing unit 420 employs circuitry optimized for matrix operations. These vector operations and matrix operations are closely related, differing mainly in their precision requirements and their data flow patterns. The processor 408 sets the operating parameters of the neural processing unit 420 or graphics processing unit 424 and provides the selected processing unit access to the frame buffer 422 to carry out image frame processing operations.

As noted, aspects of this disclosure pertain to detecting landmarks in image frames depicting a human face. Facial landmark detection can be achieved in various ways. See e.g., Chinese Utility Patent Application No. 2019-10706647.9, entitled “Detecting Spoofing Talker in a Videoconference,” filed Aug. 1, 2019, which is entirely incorporated by reference herein. In at least one example of this disclosure, there are sixty-eight landmarks (501) on a human face (500). The number of landmarks (501) detected can vary depending on various factors such as the quality of the facial data captured by the cameras (e.g., 404), the angle of the face (500) relative each camera (e.g., 404), and lighting conditions at the endpoint (e.g., 301). Of the sixty-eight facial landmarks available for analysis, in at least one example of this disclosure, nine facial landmarks (503, 505, 506, 508, 510, 511, 512, 513, 515) are used.

FIG. 5 illustrates facial landmarks 501 in accordance with an example of this disclosure. The facial landmarks 501 of face 500 include an outer right-eye-point 503, an inner right-eye-point 505, an inner left-eye-point 506, an outer left-eye-point 508, a right-side nose-point 510, a tip-of-nose-point 511, a left-side nose-point 512, a right-corner-of-mouth point 513, and a left-corner-of-mouth point 515. In at least one example of this disclosure, a facial region can be defined based on the location of the face 500 within an image frame (e.g., 102). In at least one example, a facial region can be subdivided into polygons based on locations of facial landmarks (e.g., 503, 505, 506, 508, 510, 511, 512, 513, 515), with at least some vertices of the polygons being located at facial landmarks. In some examples of this disclosure, mapping matrixes corresponding to some or all the polygons are formed. The mapping matrixes can be used to map information (e.g., pixel data) from some or all the polygons to one or more other shapes.

FIG. 6. illustrates a method 600 of rectifying facial image frames, in accordance with an example of this disclosure. At step 602, the system 300 receives a (facial) reference image frame 604 of Ms. Polly. The reference image frame 604 could come from a photograph of Ms. Polly, could be captured by a camera (e.g., 404) at a remote endpoint 302 and transmitted to the system 300, or could be retrieved from a database. The reference image frame 604 could come from other sources. In step 606, the system 300 determines a (facial) region 608 within the reference image frame 604 based on the locations of landmarks (e.g., 503, 505, 506, 508, 510, 511, 512, 513, 515) within Ms. Polly's picture 604, and partitions the region 608 into a plurality of polygons 610. In some examples of this disclosure, the polygons 610 are triangles.

At step 612, the system 300 receives another image frame 614 (e.g., 102) depicting Ms. Polly. Image frame 614 could be received from various sources, such as from a remote endpoint 302. In one or more examples of this disclosure, image frame 614 can be received within a data stream from a remote endpoint 302 during a videoconference. In at least one example of this disclosure, step 602 and step 606 are performed before such a videoconference. Ms. Polly's picture in image frame 614 (102) is blurry and of poor quality, so the system 300 will rectify the image frame 614. (As discussed, degradation of image frames can be caused by packet loss or other network/equipment issues.) At step 615, the system 300 determines a (facial) region 616 within the received image frame 614 based on the locations of landmarks (e.g., 503, 505, 506, 508, 510, 511, 512, 513, 515) within the new image frame 614, and partitions the region 616 into a plurality of polygons 618. In some examples of this disclosure, the polygons 618 are triangles.

At step 620, the system 300 maps 621 pixel information from polygons 610 of region 608 of the reference image frame 604 to corresponding polygons 618 determined from region 616. Mapping 621 of pixel information from one polygon (e.g., 610′) to another polygon (e.g., 618′) can be achieved by the system 300 using various techniques. See e.g., J. Burkardt, “Mapping Triangles,” Information Technology Department, Virginia Tech, Dec. 23, 2010, which is fully incorporated by reference herein.

Reference image frame 604 and received image frame 614 are both based on pictures of Ms. Polly, thus there is a (scalable) relationship between the relative positions of landmarks (501) in the reference image frame 604 and the relative positions of landmarks (501) in the received image frame 614, (e.g., landmarks 503, 505, 506, 508 of Ms. Polly's eyes are always closer to landmarks of her nose 510-512 than the landmarks of her mouth 513, 515). The scalable relationship between the relative positions of the landmarks in the two image frames, means that when the regions are subdivided in like manner using corresponding landmarks, there will necessarily be a relationship between image data at a given point in a polygon (e.g., 610″) from the reference image frame (e.g., 604) and its corresponding polygon (e.g., 618″) in a second image frame (e.g., 614). The system 300 replaces image data in some or all of the polygons in region 616 of the received image frame 614 with translated image data from region 608 of the reference image frame 604, forming a “revised” (facial) region 622.

At step 624, the system 300 forms a composite image frame 628, in which (at least some data of) the revised facial region 622 replaces 626 (at least some data of) the original facial region 616 in the received image frame 614. In some examples of this disclosure, the composite image frame 628 can be rendered—such as by being displayed using a display device (e.g., 330)—and the method 600 ended thereafter. The level of detail and resolution of the reference image frame 604 affects detail and resolution of the composite image frame 628. It is therefore recommended that the reference image frame 604 be of sufficient quality and definition to make the subject's facial features clearly discernable and reproducible. In some examples of this disclosure, the method 600 does not end by rendering the composite image frame 628. Instead, the method 600 proceeds to step 630 and step 632, in which the received image frame 614 and the composite image frame 628 are passed to one or more neural networks (e.g., 420). At step 634 of the method 600, the system 300 uses the one or more neural networks to perform convolutional-type operations 635 on the received image frame 614 and the composite image frame 628 to produce a rectified image frame 636 (e.g., 108).

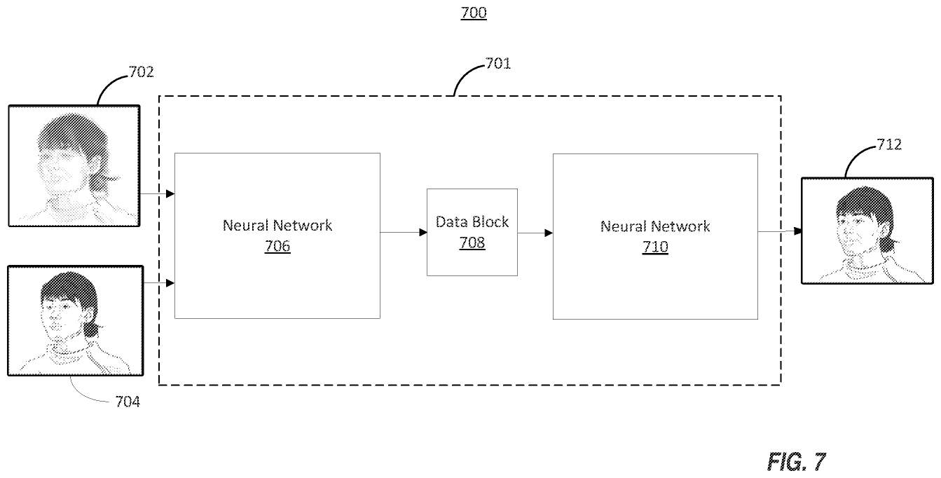

FIG. 7 illustrates an artificial neural network architecture 700, in accordance with an example of this disclosure. As shown in FIG. 7, a received image frame 702 (e.g., 102) and a composite image frame 704 (e.g., 628) are passed to a neural processor 701 (e.g., 420) which outputs a rectified image frame 712 (e.g., 108, 636). The neural processor 701 can comprise and/or have access to one or more neural networks. In the example of FIG. 7, a first neural network 706 accepts received image frame 702 and composite image frame 704 and outputs a data block 708 based on the image frame 702 and composite image frame 704. The data block 708 passes to a second neural network 710 which is used to process the data block 708 to generate the rectified image frame 712. In at least one example of this disclosure, neural network 706 has a U-Net architecture. In at least one example, neural network 710 has a very deep super resolution (VDSR) architecture.

Neural networks 706, 710, may be convolutional neural networks that support deep learning, (such as U-Net). As shown in FIG. 8, U-Net is a convolutional neural network with symmetric contracting and expanding paths to capture contextual information while also enabling precise localization. Modifications are made to the U-Net architecture to provide input image frames (e.g., 614, 628) as parallel red, green, and blue planes.

FIG. 8 is a U-Net data flow diagram 800, in accordance with an example of this disclosure. The data flow of U-Net data flow diagram 800 has a U-Net architecture. The operations of the U-Net architecture are “convolutional” in the sense that each pixel value of a result plane is derived from a corresponding block of input pixels using a set of coefficients that are consistent across the result plane. In FIG. 8, a first input layer 802, corresponding to a composite image frame (e.g., 704) and a second input layer 812, corresponding to the received image frame (e.g., 702) are accepted. The set of coefficients for the first operation (performed on input layer 802) corresponds to an input pixel volume of 3-by-3-by-N (3 pixels wide, 3 pixels high, and N planes deep), where N corresponds to the number of planes in the input layer (3 planes for input layer 802, and three planes for input layer 812). Each plane in a result layer gets its own set of coefficients. The first result layer 804 has 64 feature planes. The input pixel values are scaled by the coefficient values, and the scaled values are summed and “rectified”. The rectified linear unit operation (ReLU) passes any positive sums through but replaces any negative sums with zero.

A second result layer 806 is derived from the first result layer 804 using different coefficient sets corresponding to a pixel volume 3-by-3-by-64. The number of feature planes in the second result layer 806 is kept at 64. A subset of result layer 806 contains facial image data and forms a feature map 810.

As with the first operation on input layer 802, the set of coefficients for the first operation on input layer 812 corresponds to an input pixel volume of 3-by-3-by-N (3 pixels wide, 3 pixels high, and N planes deep), where N corresponds to the number of planes in input layer 812 (e.g., three), and each plane in a result layer gets its own set of coefficients. Thus, result layer 814 has 64 feature planes. As with input layer 802, the input pixel values of input layer 812 are scaled by the coefficient values, and the scaled values are summed and “rectified.” The rectified linear unit operation (ReLU) passes any positive sums through but replaces any negative sums with zero.

Result layer 816 is derived from prior first result layer 814 using different coefficient sets corresponding to a pixel volume 3-by-3-by-64. The number of feature planes in result layer 816 is kept at 64. A subset of result layer 816 contains facial image data and forms a second (facial) feature map 820. An eltwise operation is performed on layer 806 and layer 816 which produces layer 822.

The U-Net architecture then applies a “2-by-2 max pooling operation with stride 2 for down-sampling” to layer 822 and layer 816, meaning that each 2-by-2 block of pixels in a layer 822 and layer 816 is replaced by a single pixel in a corresponding plane of the down-sampled result layer. The number of planes remains at 64, but the width and height of the planes is reduced by half.

Result layer 826 is derived from down-sampled result layer 824, using additional 3-by-3-by-64 coefficient sets to double the number of planes from 64 to 128. Result layer 828 is derived from result layer 826 using coefficient sets of 3-by-3-by-128. In some examples of this disclosure, result layer 828 contains a feature map 830.

Result layer 834 is derived from down-sampled result layer 832, using additional 3-by-3-by-64 coefficient sets to double the number of planes from 64 to 128. Result layer 836 is derived from result layer 834 using coefficient sets of 3-by-3-by-128. In some examples of this disclosure, result layer 836 contains a feature map 840. An eltwise operation is performed on result layer 828 and result layer 836 to produce result layer 842.

A 2-by-2 max pooling operation is applied to result layer 842 and result layer 836, producing down-sampled layer 844 and down-sampled layer 852 having width and height dimensions a quarter of the original image frame dimensions. The depth of down-sampled layer 844 and down-sampled layer 852 is 128.

Result layer 854 is derived from down-sampled result layer 852, using additional 3-by-3-by-128 coefficient sets to double the number of feature planes from 128 to 256. Result layer 856 is derived from result layer 854 using coefficient sets of 2-by-3-by-256. In at least one example of this disclosure, result layer 856 contains a feature map 858.

Result layer 846 is derived from down-sampled result layer 844, using additional 3-by-3-by-128 coefficient sets to double the number of feature planes from 128 to 256. Result layer 848 is derived from result layer 846 using coefficient sets of 2-by-3-by-256. In at least one example of this disclosure, result layer 848 contains a feature map 850. An eltwise operation if performed on result layer 856 and result layer 848 to produce result layer 860.

A 2-by-2 max pooling operation is applied to result layer 848 and result layer 860 to produce down-sampled result layer 862 and down-sampled result layer 870, each having width and height dimensions one eighth of the original image frame dimensions. The depth of down-sampled result layer 862 and down-sampled result layer 870 is 256.

In similar fashion, result layer 872 is derived from down-sampled result layer 870 and result layer 874 is derived from result layer 872, while result layer 864 is derived from down-sampled result layer 862 and result layer 866 is derived from result layer 864. In at least one example of this disclosure, result layer 874 comprises a feature map 876 and result layer 866 comprises a feature map 868. An eltwise operation is performed on result layer 874 and result layer 866 to produce result layer 878 having a depth of 512. Result layer 878 is down-sampled to produce down-sampled result layer 880. Result layer 882 is derived from down-sampled result layer 880, and result layer 884 is derived from result layer 882. The pixel values in the planes of layer 862, layer 870, and layer 880 are repeated to double the width and height of each plane. Thereafter, the U-Net begins up-sampling. A set of 2-by-2-by-N convolutional coefficients is used to condense the number of up-sampled planes by half. Result layer 878 is concatenated with the condensed layer 884, forming a first concatenated layer 886 having 1024 planes.

Result layer 888 is derived from the first concatenated layer 886, using 512 coefficient sets of size 3-by-3-by-1024. Result layer 890 is derived from result layer 888 using 512 coefficient sets of size 3-by-3-by-512. A second concatenated layer 892 is derived by up-sampling result layer 890, condensing the result, and concatenating the result with result layer 860. 256 coefficient sets of size 3-by-3-by-512 are used to derive result layer 894 from the second concatenated layer 892, and 256 coefficient sets of size 3-by-3-by-256 work to derive result layer 896 from result layer 894.

A third concatenated result layer 898 is derived from result layer 896 using up-sampling, condensing, and concatenation with result layer 842. Result layer 803 and result layer 805 are derived in turn, and result layer 805 is up-sampled, condensed, and concatenated with result layer 822 to form fourth concatenated layer 807. Result layer 811 is derived from fourth concatenated layer 807 and can be output as a data block (e.g., 708).

The number of planes in each result layer in FIG. 8 is a parameter that can be customized, as is the number of coefficients in each coefficient set. The coefficient values may be determined using a conventional neural network training procedure in which input patterns are supplied to the network to obtain a tentative output, the tentative output is compared with a known result to determine error, and the error is used to adapt the coefficient values. Various suitable training procedures are available in the open literature. More information can be found in Ronneberger, “U-Net: Convolutional Networks for Biomedical Image Segmentation”, arXiv:1505.04597v1 [cs.CV] 18 May 2015.

FIG. 9 is a VDSR data flow diagram of a neural network 900, in accordance with an example of this disclosure. In at least one example of this disclosure, neural network 900 uses a VDSR architecture. Neural network 900 receives a data block 904 (e.g., 708, 811) as input. In at least one example of this disclosure, data block 904 is the fourth concatenated layer 807 described in FIG. 8. Layer 906 is derived from data block 904. Layers 908, 910, 912, 914 and 916 are each derived from a preceding layer, with each of layers 906-916 having 64 feature planes, and having the width and height dimensions of the composite image frame 704 (corresponding to input layer 802) and the degraded image frame 702 (corresponding to input layer 812). Finally, the planes of result layer 916 are condensed with coefficient sets of 1-by-1-by-N to form the output layer 918, corresponding to rectified image frame 712 (e.g., 108). The number of planes in each result layer in FIG. 9 is a parameter that can be customized, as is the number of coefficients in each coefficient set. The coefficient values may be determined using a conventional neural network training procedure in which input patterns are supplied to the network to obtain a tentative output, the tentative output is compared with a known result to determine error, and the error is used to adapt the coefficient values. More information concerning VDSR can be found in S. Tsang, “Review: VDSR (Super Resolution),” TowardsDataScience.Com, Oct. 30, 2018.

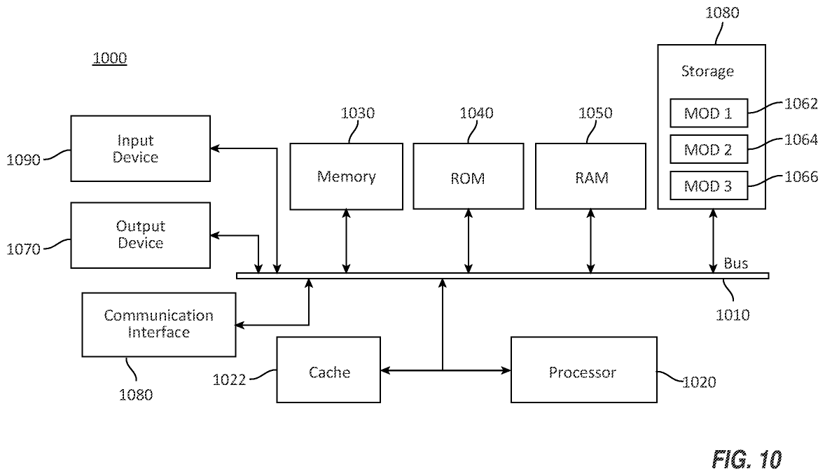

FIG. 10 illustrates an electronic device 1000 (e.g., 300, 400) which can be employed to practice the concepts and methods described. The components disclosed described can be incorporated in whole or in part into tablet computers, personal computers, handsets, and other devices utilizing one or more input devices 1090 such as microphones, keyboards, etc. As shown, device 1000 can include a processing unit (CPU or processor) 1020 (e.g., 408) and a system bus 1010 (e.g., 416). System bus 1010 interconnects various system components—including the system memory 1030 such as read only memory (ROM) 1040 and random-access memory (RAM) 1050—to the processor 1020. The bus 1010 connects processor 1020 and other components to a communication interface 1060 (e.g., 116). The processor 1020 can comprise one or more digital signal processors. The device 1000 can include a cache 1022 of high-speed memory connected directly with, near, or integrated as part of the processor 1020. The device 1000 copies data from the memory 1030 and/or the storage device 1080 to the cache 1022 for quick access by the processor 1020. In this way, the cache provides a performance boost that avoids processor 1020 delays while waiting for data. These and other modules can control or be configured to control the processor 1020 to perform various actions. Other system memory 1030 may be available for use as well. The memory 1030 can include multiple different types of memory with different performance characteristics. The processor 1020 can include any general-purpose processor and a hardware module or software module, such as module 1 (1062), module 2 (1064), and module 3 (1066) stored in storage device 1080, operable to control the processor 1020 as well as a special-purpose processor where software instructions are incorporated into the actual processor design. The processor 1020 may essentially be a completely self-contained computing system, containing multiple cores or processors, a bus, memory controller, cache, etc. A multi-core processor may be symmetric or asymmetric.

The system bus 1010 may be any of several types of bus structures including a memory bus or memory controller, a peripheral bus, and a local bus using any of a variety of bus architectures. A basic input/output system (BIOS) stored in ROM 1040 or the like, may provide the basic routine that helps to transfer information between elements within the device 1000, such as during start-up. The device 1000 further includes storage devices 1080 such as a hard disk drive, a magnetic disk drive, an optical disk drive, tape drive or the like. The storage device 1080 can include software modules 1062, 1064, 1066 for controlling the processor 1020. Other hardware or software modules are contemplated. The storage device 1080 is connected to the system bus 1010 by a drive interface. The drives and the associated computer readable storage media provide nonvolatile storage of computer readable instructions, data structures, program modules and other data for the device 1000. In at least one example, a hardware module that performs a function includes the software component stored in a non-transitory computer-readable medium coupled to the hardware components—such as the processor 1020, bus 1010, output device 1070, and so forth—necessary to carry out the function.

For clarity of explanation, the device of FIG. 10 is presented as including individual functional blocks including functional blocks labeled as a “processor.” The functions these blocks represent may be provided using either shared or dedicated hardware, including, but not limited to, hardware capable of executing software and hardware, such as a processor 1020, that is purpose-built to operate as an equivalent to software executing on a general-purpose processor. For example, the functions of one or more processors presented in FIG. 10 may be provided by a single shared processor or multiple processors. (Use of the term “processor” should not be construed to refer exclusively to hardware capable of executing software.) One or more examples of this disclosure include microprocessor hardware, and/or digital signal processor (DSP) hardware, read-only memory (ROM) 1040 for storing software performing the operations discussed in one or more examples below, and random-access memory (RAM) 1050 for storing results. Very large-scale integration (VLSI) hardware examples, as well as custom VLSI circuitry in combination with a general-purpose DSP circuit can also be used.

Examples of this disclosure include the following examples:

1. A method (200, 600) of rectifying images in a videoconference, comprising: receiving (202) a first image frame (604); determining locations of first feature landmarks (501) corresponding to the first image frame (604); determining (606) a first region (608) corresponding to the first image frame (604), based on the locations of the first feature landmarks (501); partitioning the first region (608) into a first plurality of polygons (610) based on the locations of the first feature landmarks (501); receiving a second image frame (102, 614); determining locations of second feature landmarks (501) corresponding to the second image frame (102, 614); determining a second region (616) corresponding to the second image frame (102, 614), based on the locations of the second feature landmarks (501); partitioning the second region (616) into a second plurality of polygons (618) based on the locations of the second feature landmarks (501); translating image data of one or more polygons (610) of the first plurality of polygons (610) to one or more polygons of the second plurality of polygons (618); and forming a composite image frame by replacing image data of at least one polygon in the second plurality of polygons (618) with translated image data from the one or more polygons (610) of the first plurality of polygons (610).

2. The method (200, 600) of example 1, further comprising: receiving (202) the first image frame (604) at a neural processing unit; receiving the composite image frame at the neural processing unit; and forming a rectified image frame using the neural processing unit, based on the first image frame (604) and the composite image frame.

3. The method (200, 600) of example 1, wherein: partitioning the first region (608) into the first plurality of polygons (610) based on the locations of the first feature landmarks (501) comprises partitioning the first region (608) into a first quantity of polygons; partitioning the second region (616) into the second plurality of polygons (618) based on the locations of the second feature landmarks (501) comprises partitioning the second region (616) into a second quantity of polygons; and the second quantity of polygons is equal to the first quantity of polygons.

4. The method (200, 600) of example 1, wherein: determining locations of first feature landmarks (501) corresponding to the first image frame (604) comprises determining locations of first facial feature landmarks (501) corresponding to the first image frame (604); determining (606) the first region (608) corresponding to the first image frame (604), based on the locations of the first feature landmarks (501) comprises determining (606) a first facial region corresponding to the first image frame (604), based on the locations of the first facial feature landmarks (501); partitioning the first region (608) into the first plurality of polygons (610) based on the locations of the first feature landmarks (501) comprises partitioning the first facial region into the first plurality of polygons (610) based on the locations of the first facial feature landmarks (501); determining locations of second feature landmarks (501) corresponding to the second image frame (102, 614) comprises determining locations of second facial feature landmarks (501) corresponding to the second image frame (102, 614); determining the second region (616) corresponding to the second image frame (102, 614), based on the locations of the second feature landmarks (501) comprises determining a second facial region corresponding to the second image frame (102, 614), based on the locations of the second facial feature landmarks (501); partitioning the second region (616) into a second plurality of polygons (618) based on the locations of the second feature landmarks (501) comprises partitioning the second facial region into the second plurality of polygons (618) based on the locations of the second facial feature landmarks (501); and translating image data of one or more polygons (610) of the first plurality of polygons (610) to one or more polygons of the second plurality of polygons (618) comprises mapping (621) facial image data of one or more polygons (610) of the first plurality of polygons (610) to one or more polygons of the second plurality of polygons (618).

5. The method (200, 600) of example 4, wherein: receiving (202) the first image frame (604) comprises retrieving a first image depicting a person, the first image being of a first quality; and receiving the second image frame (102, 614) comprises receiving the second image frame (102, 614) within a data stream initiated at a remote videoconferencing system (100), the second image frame depicting the person and being of a second quality, wherein the second quality is inferior to first quality.

6. The method (200, 600) of example 5, further comprising: receiving (202) the first image frame (604) at a neural processing unit; receiving the composite image frame at the neural processing unit; forming a rectified image frame using the neural processing unit, based on the first image frame (604) and the composite image frame; and rendering the rectified image frame, wherein rendering the rectified image frame comprises displaying an image depicting the person.

7. The method (200, 600) of example 6, wherein rendering the rectified image frame further comprises displaying the image depicting the person within a predetermined period of receiving the second image frame (102, 614) at a videoconferencing system (100). In at least one example, the predetermined period is 80 milliseconds.

8. The method (200, 600) of example 6, further comprising: receiving a third image frame, the third image frame corresponding to the rectified image frame; determining locations of third feature landmarks (501) corresponding to the third image frame; determining (606) a third region corresponding to the third image frame, based on the locations of the third feature landmarks (501); partitioning the third region into a third plurality of polygons based on the locations of the third feature landmarks (501); receiving a fourth image frame; determining locations of fourth feature landmarks (501) corresponding to the fourth image frame; determining a fourth region corresponding to the fourth image frame, based on the locations of the fourth feature landmarks (501); partitioning the fourth region into a fourth plurality of polygons based on the locations of the fourth feature landmarks (501); translating image data of one or more polygons of the third plurality of polygons to one or more polygons of the fourth plurality of polygons; and forming a composite image frame by replacing image data of at least one polygon in the fourth plurality of polygons with translated image data from the one or more polygons of the third plurality of polygons.

9. The method (200, 600) of example 6, wherein: receiving (202) the first image frame (604) at the neural processing unit comprises receiving (202) the first image frame (604) at a processing unit comprising a U-net architecture; and receiving the composite image frame at the neural processing unit comprises receiving the composite image frame at the processing unit having the U-net architecture.

10. The method (200, 600) of example 9, wherein: receiving (202) the first image frame (604) at the neural processing unit further comprises receiving (202) the first image frame (604) at a processing unit comprising a VDSR architecture; and receiving the composite image frame at the neural processing unit receiving further comprises receiving the composite image frame at the processing unit having the VDSR architecture.

11. The method (200, 600) of example 1, wherein: determining locations of first feature landmarks (501) corresponding to the first image frame (604) comprises discerning first facial feature landmarks (501); and determining locations of second feature landmarks (501) corresponding to the second image frame (102, 614) comprises discerning second facial feature landmarks (501).

12. A videoconferencing system (100) with video image rectification, the videoconferencing system (100) comprising a processor (408, 1020), wherein the processor (408, 1020) is operable to: receive a first image frame (604); determine locations of first feature landmarks (501) corresponding to the first image frame (604); determine a first region (608) corresponding to the first image frame (604), based on the locations of the first feature landmarks (501); partition the first region (608) into a first plurality of polygons (610) based on the locations of the first feature landmarks (501); receive a second image frame (102, 614); determine locations of second feature landmarks (501) corresponding to the second image frame (102, 614); determine a second region (616) corresponding to the second image frame (102, 614), based on the locations of the second feature landmarks (501); partition the second region (616) into a second plurality of polygons (618) based on the locations of the second feature landmarks (501); translate image data of one or more polygons (610) of the first plurality of polygons (610) to one or more polygons of the second plurality of polygons (618); and form a composite image frame by replacing image data of at least one polygon in the second plurality of polygons (618) with translated image data from the one or more polygons (610) of the first plurality of polygons (610).

13. The videoconferencing system (100) of example 12, further comprising a neural processor, wherein the neural processor is further operable to: receive the first image frame (604) at a neural processing unit; receive the composite image frame at the neural processing unit; and form a rectified image frame using the neural processing unit, based on the first image frame (604) and the composite image frame.

14. The videoconferencing system (100) of example 12, wherein the processor (408, 1020) is further operable to: partition the first region (608) into the first plurality of polygons (610) based on the locations of the first feature landmarks (501) by partitioning the first region (608) into a first quantity of polygons; and partition the second region (616) into the second plurality of polygons (618) based on the locations of the second feature landmarks (501) by partitioning the second region (616) into a second quantity of polygons equal to the first quantity of polygons.

15. The videoconferencing system (100) of example 12, wherein the processor (408, 1020) is further operable to: determine locations of first feature landmarks (501) corresponding to the first image frame (604) by determining locations of first facial feature landmarks (501) corresponding to the first image frame (604); determine (606) the first region (608) corresponding to the first image frame (604), based on the locations of the first feature landmarks (501) by determining (606) a first facial region corresponding to the first image frame (604), based on the locations of the first facial feature landmarks (501); partition the first region (608) into the first plurality of polygons (610) based on the locations of the first feature landmarks (501) by partitioning the first facial region into the first plurality of polygons (610) based on the locations of the first facial feature landmarks (501); determine locations of second feature landmarks (501) corresponding to the second image frame (102, 614) by determining locations of second facial feature landmarks (501) corresponding to the second image frame (102, 614); determine the second region (616) corresponding to the second image frame (102, 614), based on the locations of the second feature landmarks (501) by determining a second facial region corresponding to the second image frame (102, 614), based on the locations of the second facial feature landmarks (501); partition the second region (616) into a second plurality of polygons (618) based on the locations of the second feature landmarks (501) by partitioning the second facial region into the second plurality of polygons (618) based on the locations of the second facial feature landmarks (501); and translate image data of one or more polygons (610) of the first plurality of polygons (610) to one or more polygons of the second plurality of polygons (618) by mapping (621) facial image data of one or more polygons (610) of the first plurality of polygons (610) to one or more polygons of the second plurality of polygons (618).

16. The videoconferencing system (100) of example 15, wherein the processor (408, 1020) is further operable to: receive the first image frame (604) by retrieving a first image depicting a person, the first image being of a first quality; and receive the second image frame (102, 614) by receiving the second image frame (102, 614) within a data stream initiated at a remote videoconferencing system (100), the second image frame depicting the person and being of a second quality, wherein the second quality is inferior to first quality.

17. The videoconferencing system (100) of example 16, further comprising a neural processing unit, wherein the neural processing unit is operable to: receive the first image frame (604); receive the composite image frame; form a rectified image frame based on the first image frame (604) and the composite image frame; provide the rectified image frame to the processor (408, 1020), wherein the processor (408, 1020) is further operable to cause a display device to display an image depicting the person based on the rectified image frame.

18. The videoconferencing system (100) of example 17, wherein the processor (408, 1020) is further operable to: cause the display device to display the image depicting the person based on the rectified image frame within a predetermined period of receiving the second image frame (102, 614). In at least one example, the predetermined period is sixty milliseconds.

19. The videoconferencing system (100) of example 17, wherein the processor (408, 1020) is further operable to: receive a third image frame, the third image frame corresponding to the rectified image frame; determine locations of third feature landmarks (501) corresponding to the third image frame; determine a third region corresponding to the third image frame, based on the locations of the third feature landmarks (501); partition the third region into a third plurality of polygons based on the locations of the third feature landmarks (501); receive a fourth image frame; determine locations of fourth feature landmarks (501) corresponding to the fourth image frame; determine a fourth region corresponding to the fourth image frame, based on the locations of the fourth feature landmarks (501); partition the fourth region into a fourth plurality of polygons based on the locations of the fourth feature landmarks (501); translate image data of one or more polygons of the third plurality of polygons to one or more polygons of the fourth plurality of polygons; and form a composite image frame by replacing image data of at least one polygon in the fourth plurality of polygons with translated image data from the one or more polygons of the third plurality of polygons.

20. The videoconferencing system (100) of example 12, wherein the processor (408, 1020) is further operable to: determine locations of first feature landmarks (501) corresponding to the first image frame (604) by discerning first facial feature landmarks (501); and determine locations of second feature landmarks (501) corresponding to the second image frame (102, 614) by discerning second facial feature landmarks (501).

21. The videoconferencing system of example 19, wherein the neural processor (420, 701) is further operable to: receive the third image frame; receive the second composite image frame; form a second rectified image frame based on the third image frame and the second composite image frame; and provide the second rectified image frame to the processor (408, 1020), wherein the processor (408, 1020) is further operable to cause a display device to display an image depicting the person based on the second rectified image frame.

The various examples within this disclosure are provided by way of illustration and should not be construed to limit the scope of the disclosure. Various modifications and changes can be made to the principles and examples described herein without departing from the scope of the disclosure and without departing from the claims which follow.

It is claimed:

1. A method of rectifying images in a videoconference, comprising:
receiving a first image frame;
determining locations of first feature landmarks corresponding to the first image frame;
determining a first region corresponding to the first image frame, based on the locations of the first feature landmarks;
partitioning the first region into a first plurality of polygons based on the locations of the first feature landmarks;
receiving a second image frame;
determining locations of second feature landmarks corresponding to the second image frame;
determining a second region corresponding to the second image frame, based on the locations of the second feature landmarks;
partitioning the second region into a second plurality of polygons based on the locations of the second feature landmarks;
translating image data of one or more polygons of the first plurality of polygons to one or more polygons of the second plurality of polygons; and
forming a composite image frame by replacing image data of at least one polygon in the second plurality of polygons with translated image data from the one or more polygons of the first plurality of polygons.

2. The method of claim 1, further comprising:
receiving the first image frame at a neural processing unit;
receiving the composite image frame at the neural processing unit; and
forming a rectified image frame using the neural processing unit, based on the first image frame and the composite image frame.

3. The method of claim 1, wherein:
partitioning the first region into the first plurality of polygons based on the locations of the first feature landmarks comprises partitioning the first region into a first quantity of polygons;
partitioning the second region into the second plurality of polygons based on the locations of the second feature landmarks comprises partitioning the second region into a second quantity of polygons; and
the second quantity of polygons is equal to the first quantity of polygons.

4. The method of claim 1, wherein:
determining locations of first feature landmarks corresponding to the first image frame comprises determining locations of first facial feature landmarks corresponding to the first image frame;
determining the first region corresponding to the first image frame, based on the locations of the first feature landmarks comprises determining a first facial region corresponding to the first image frame, based on the locations of the first facial feature landmarks;
partitioning the first region into the first plurality of polygons based on the locations of the first feature landmarks comprises partitioning the first facial region into the first plurality of polygons based on the locations of the first facial feature landmarks;
determining locations of second feature landmarks corresponding to the second image frame comprises determining locations of second facial feature landmarks corresponding to the second image frame;
determining the second region corresponding to the second image frame, based on the locations of the second feature landmarks comprises determining a second facial region corresponding to the second image frame, based on the locations of the second facial feature landmarks;
partitioning the second region into a second plurality of polygons based on the locations of the second feature landmarks comprises partitioning the second facial region into the second plurality of polygons based on the locations of the second facial feature landmarks; and
translating image data of one or more polygons of the first plurality of polygons to one or more polygons of the second plurality of polygons comprises mapping facial image data of one or more polygons of the first plurality of polygons to one or more polygons of the second plurality of polygons.

5. The method of claim 4, wherein:
receiving the first image frame comprises retrieving a first image depicting a person, the first image being of a first quality; and
receiving the second image frame comprises receiving the second image frame within a data stream initiated at a remote videoconferencing system, the second image frame depicting the person and being of a second quality, wherein the second quality is inferior to first quality.

6. The method of claim 5, further comprising:
receiving the first image frame at a neural processing unit;
receiving the composite image frame at the neural processing unit;
forming a rectified image frame using the neural processing unit, based on the first image frame and the composite image frame; and
rendering the rectified image frame, wherein rendering the rectified image frame comprises displaying an image depicting the person.

7. The method of claim 6, wherein rendering the rectified image frame further comprises displaying the image depicting the person within a predetermined period of receiving the second image frame at a videoconferencing system.

8. The method of claim 6, further comprising:
receiving a third image frame, the third image frame corresponding to the rectified image frame;
determining locations of third feature landmarks corresponding to the third image frame;
determining a third region corresponding to the third image frame, based on the locations of the third feature landmarks;
partitioning the third region into a third plurality of polygons based on the locations of the third feature landmarks;
receiving a fourth image frame;
determining locations of fourth feature landmarks corresponding to the fourth image frame;
determining a fourth region corresponding to the fourth image frame, based on the locations of the fourth feature landmarks;
partitioning the fourth region into a fourth plurality of polygons based on the locations of the fourth feature landmarks;
translating image data of one or more polygons of the third plurality of polygons to one or more polygons of the fourth plurality of polygons; and
forming a composite image frame by replacing image data of at least one polygon in the fourth plurality of polygons with translated image data from the one or more polygons of the third plurality of polygons.

9. The method of claim 6, wherein:
receiving the first image frame at the neural processing unit comprises receiving the first image frame at a processing unit comprising a U-net architecture; and
receiving the composite image frame at the neural processing unit comprises receiving the composite image frame at the processing unit having the U-net architecture.

10. The method of claim 9, wherein:
receiving the first image frame at the neural processing unit further comprises receiving the first image frame at a processing unit comprising a VDSR architecture; and
receiving the composite image frame at the neural processing unit receiving further comprises receiving the composite image frame at the processing unit having the VDSR architecture.

11. The method of claim 1, wherein:
determining locations of first feature landmarks corresponding to the first image frame comprises discerning first facial feature landmarks; and
determining locations of second feature landmarks corresponding to the second image frame comprises discerning second facial feature landmarks.

12. A videoconferencing system with video image rectification, the videoconferencing system comprising a processor (408, 1020), wherein the processor (408, 1020) is operable to:
receive a first image frame;
determine locations of first feature landmarks corresponding to the first image frame;
determine a first region corresponding to the first image frame, based on the locations of the first feature landmarks;
partition the first region into a first plurality of polygons based on the locations of the first feature landmarks;
receive a second image frame;
determine locations of second feature landmarks corresponding to the second image frame;
determine a second region corresponding to the second image frame, based on the locations of the second feature landmarks;
partition the second region into a second plurality of polygons based on the locations of the second feature landmarks;
translate image data of one or more polygons of the first plurality of polygons to one or more polygons of the second plurality of polygons; and
form a composite image frame by replacing image data of at least one polygon in the second plurality of polygons with translated image data from the one or more polygons of the first plurality of polygons.

13. The videoconferencing system of claim 12, further comprising a neural processor, wherein the neural processor is operable to:
receive the first image frame;
receive the composite image frame; and
form a rectified image frame based on the first image frame and the composite image frame.

14. The videoconferencing system of claim 12, wherein the processor is further operable to:
partition the first region into the first plurality of polygons based on the locations of the first feature landmarks by partitioning the first region into a first quantity of polygons; and
partition the second region into the second plurality of polygons based on the locations of the second feature landmarks by partitioning the second region into a second quantity of polygons equal to the first quantity of polygons.

15. The videoconferencing system of claim 12, wherein the processor is further operable to:
determine locations of first feature landmarks corresponding to the first image frame by determining locations of first facial feature landmarks corresponding to the first image frame;
determine the first region corresponding to the first image frame, based on the locations of the first feature landmarks by determining a first facial region corresponding to the first image frame, based on the locations of the first facial feature landmarks;
partition the first region into the first plurality of polygons based on the locations of the first feature landmarks by partitioning the first facial region into the first plurality of polygons based on the locations of the first facial feature landmarks;
determine locations of second feature landmarks corresponding to the second image frame by determining locations of second facial feature landmarks corresponding to the second image frame;
determine the second region corresponding to the second image frame, based on the locations of the second feature landmarks by determining a second facial region corresponding to the second image frame, based on the locations of the second facial feature landmarks;
partition the second region into a second plurality of polygons based on the locations of the second feature landmarks by partitioning the second facial region into the second plurality of polygons based on the locations of the second facial feature landmarks; and
translate image data of one or more polygons of the first plurality of polygons to one or more polygons of the second plurality of polygons by mapping facial image data of one or more polygons of the first plurality of polygons to one or more polygons of the second plurality of polygons.

16. The videoconferencing system of claim 15, wherein the processor is further operable to:
receive the first image frame by retrieving a first image depicting a person, the first image being of a first quality; and
receive the second image frame by receiving the second image frame within a data stream initiated at a remote videoconferencing system, the second image frame depicting the person and being of a second quality, wherein the second quality is inferior to first quality.

17. The videoconferencing system of claim 16, further comprising a neural processor, wherein the neural processor is operable to:
receive the first image frame;
receive the composite image frame;
form a rectified image frame based on the first image frame and the composite image frame; and
provide the rectified image frame to the processor, wherein the processor is further operable to cause a display device to display an image depicting the person based on the rectified image frame.

18. The videoconferencing system of claim 17, wherein the processor is further operable to:
cause the display device to display the image depicting the person based on the rectified image frame within a predetermined period of receiving the second image frame.

19. The videoconferencing system of claim 17, wherein the processor is further operable to:
receive a third image frame, the third image frame corresponding to the rectified image frame;
determine locations of third feature landmarks corresponding to the third image frame;
determine a third region corresponding to the third image frame, based on the locations of the third feature landmarks;
partition the third region into a third plurality of polygons based on the locations of the third feature landmarks;
receive a fourth image frame;
determine locations of fourth feature landmarks corresponding to the fourth image frame;
determine a fourth region corresponding to the fourth image frame, based on the locations of the fourth feature landmarks;
partition the fourth region into a fourth plurality of polygons based on the locations of the fourth feature landmarks;
translate image data of one or more polygons of the third plurality of polygons to one or more polygons of the fourth plurality of polygons; and
form a second composite image frame by replacing image data of at least one polygon in the fourth plurality of polygons with translated image data from the one or more polygons of the third plurality of polygons.

20. The videoconferencing system of claim 19, wherein the neural processor is further operable to:
receive the third image frame;
receive the second composite image frame;
form a second rectified image frame based on the third image frame and the second composite image frame; and
provide the second rectified image frame to the processor, wherein the processor is further operable to cause a display device to display an image depicting the person based on the second rectified image frame.
